(19) United States
(12) Patent Application Publication
(10) Pub. No.: US 2014/0230311 A1
(43) Pub. Date: Aug. 21, 2014

(54) Novelty Fish Lure

(71) Applicant: Gary Wayne Woodley, Estacada, OR (US)

(72) Inventor: Gary Wayne Woodley, Estacada, OR (US)

(21) Appl. No.: 14/186,348

(22) Filed: Feb. 21, 2014

Related U.S. Application Data
(60) Provisional application No. 61/767,430, filed on Feb. 21, 2013.

(51) Int. Cl. A01K 85/01

(52) U.S. Cl. CPC A01K 85/01
USPC 43/42.31

(57) ABSTRACT

The present invention contemplates a novelty fish lure having a life-like fish-shaped body member defining at least one interior chamber. The interior chamber adapts to receive an activation button in communication with a pre-recorded sound board in communication with an audio speaker. The pre-recorded sound consists of a human voice recording of short, humorous phrases.

### PRIORITY CLAIM

The present application claims benefit for all purposes co-pending U.S. Provisional Patent Application Ser. No. 61/767,430 filed on 21 Feb. 2013: The present application is based on and claims priority from this application, the disclosure of which is hereby expressly incorporated herein by reference.

### BACKGROUND

The present invention relates to novelty items, specifically novelty fishing lures.

Fishing, or angling, is a multi-billion dollar industry supported by weekend recreationalist, to full-time professional fishermen. Sales of fishing lures contribute a substantial percentage of this multi-billion dollar industry. Despite the seriousness that many fishermen or anglers bring to the sport and business, an element of whimsy or fun is most often well appreciated. Novelty fish items lure the gift-buying public who wish to amuse their angler friends.

Examples of novelty fish lures include the device of Malouf et al. described in U.S. Pat. No. 6,082,037 issued on 2000 Jul. 4. Therein Malouf et al. teaches a novelty fishing-lure made from a plurality of coins forming the body of the lure.

Returning to the more serious business and sport of angling, non-novelty fish lures are designed to attract fish and incorporating sound is one common known way to make an artificial lure more likely to bait a fish. One such lure includes an artificial fishing lure described by Parker in U.S. Pat. No. 3,894,350 issued on 1975 Jul. 15. Parker teaches a generally fish-shaped artificial lure having a pellet captured within a noise chamber. An acoustic chamber amplifies sound through a passageway interconnecting the noise and amplification chambers.

Another example of a non-novelty fishing lure includes a fishing lure having a controlled rattle described by Jensen et al. in U.S. Pat. No. 7,827,730 issued on 2010 Nov. 09. Therein Jensen et al teach an adjustable rattle having a rattling mode and a muted mode encapsulated in a fish-shaped body having an interior rattle chamber and a muted chamber with a channel connecting the two chambers.

Despite these known novelty and non-novelty fishing lures, there remains a need for a novelty fishing lure that includes sound.

### DRAWING

FIG. 1 is a front view of one embodiment of the present invention.

FIG. 2 is a photograph showing the front view of another embodiment of the present invention.

FIG. 3 is a cut-away photograph showing the inside of the device of FIG. 2.

FIG. 4 is a front view of a preferred embodiment of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

In one contemplated embodiment, the present invention consists of a novelty fish lure having an exterior body that appears as realistic looking fish body. And, as any fishing lure, at least one hook-like device suspends from the body. However, unlike traditional fishing lures, in one possible embodiment the present invention includes a water-impervious inner chamber that is adapted to contain an audio speaker. In a preferred embodiment, the body is made from a more rigid plastic and is not necessarily waterproof as it is not intended to function as a fishing lure, but rather to be a novelty item. In either embodiment, the audio speaker is in communication with a circuit board assembly having a pre-recorded sound. An activation button is in communication with the board and the activation button can be activated or depressed through the body.

One contemplated body material is silicone, as would be commonly understood by those skilled in the art. This material is very pliable and soft and can be shaped as required. Because this material is so pliable, the activation button can easily be depressed, while still remaining under this skin.

In a preferred embodiment, the body is made from a more rigid plastic, such as ABS. In this embodiment, the activation button protrudes through the skin, as would be conventionally understood in the art.

In either contemplated embodiment, the exterior of the body 11 is molded or shaped to appear as a real fish skin and then painted or dyed to appear to have scales, color, and sheen. The skin can be thick enough so to provide enough stability to the device so an internal skeleton frame is not required. Further, the skin can be molded in two parts and then an adhesive can be used to seal the two halves once the interior components are installed. The interior components can be adhered to an inside wall of one half of the body.

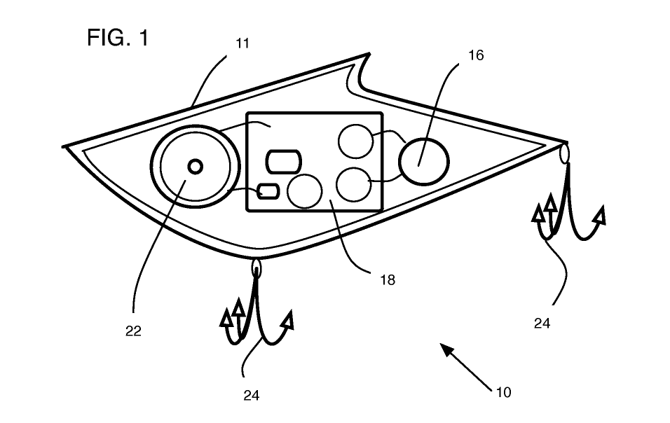

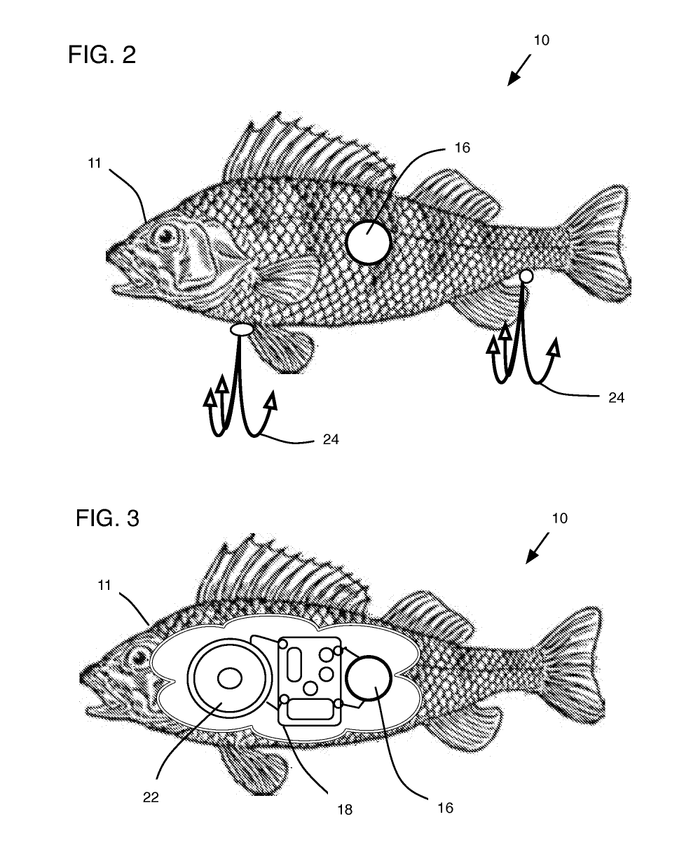

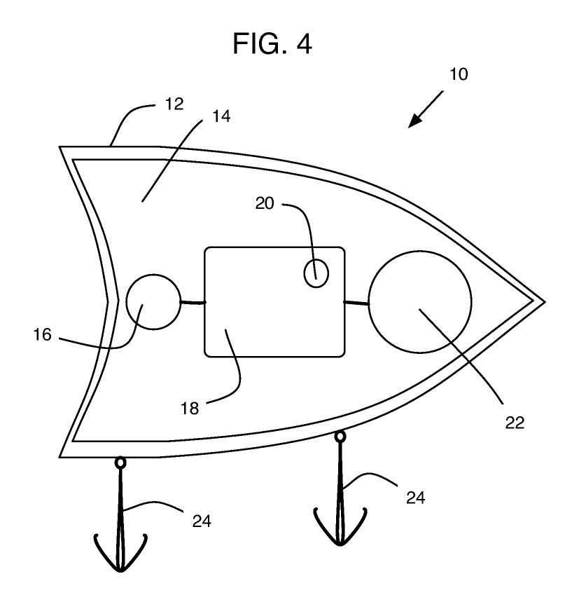

FIGS. 1-3 illustrate one contemplated embodiment of the present invention. FIG. 4 details the interior components of one preferred embodiment of the present invention. As such, a novelty fish lure 10 includes a body 12 having one or more hooks 24 suspended from the body. The body surrounds an interior chamber 14. The chamber encapsulates and holds an activation button 16, which is in communication with a sound circuit board 18 having a power source 20, such as a lithium-ion battery, for example. An audio speaker 22 is in communication with the board so that when the activation button is depressed, a pre-recorded sound plays through the speaker.

Part of the gag or novelty affect of the present invention is for the device 10 to appear like a conventional fishing lure that would be used by anglers to bait fish. However, unlike non-novelty fishing lures, the novelty aspect is that the pre-recorded sounds are not natural bait-fish sounds that would naturally attract a fish, but rather a human voice making humorous or sarcastic sounds, words, or short phrases.

Pre-recorded sounds, specifically a human voice, are conventionally recorded on a memory chip included on the circuit board. For novelty effect, a sultry human female voice can be used and contemplated recordings include:

“Here fishy, fishy. Here I am. Come and get me. Here fishy, fishy: You know you want me. Come on: Just give me a little bite. Here fishy, fishy. Here fishy, fishy.” Or,

“Here fishy, fishy, fishy. Here fishy, fishy, fishy. You can't get me; Na,na,na,na,na,na Na,na,na,na,na,na. You can't get me; Na,na,na,na,na,na Na,na,na,na,na,na.”

Other contemplated embodiments include a device having a microphone and a record button whereby the user could be record their own message on the device. For example, a wife may purchase the novelty device and then record a funny or sincere message, such as “Darling Husband, if you go fishing one more time don't bother to come home.”

Although the invention has been particularly shown and described with reference to certain embodiments, it will be understood by those skilled in the art that various changes in form and detail may be made without departing from the spirit and scope of the invention.

I claim:

1. A novelty fish lure comprising:
a fish-shaped body member having at least one interior chamber, the interior chamber adapted to receive
an activation button in communication with
a pre-recorded sound board in communication with
an audio speaker.

2. The novelty fish lure of claim 1 further comprising:
a prerecorded sound stored on the sound board, the pre-recorded sound comprising a recording of a human voice stating “here fishy fishy”.

3. A novelty fish lure device comprising:
a body member defining an interior compartment;
an activation disposed on a portion of the body member and configured to be operable;
an electronic circuit board arranged in the interior compartment and in electrical communication with the activation button and configured to play a pre-recorded sound, the electronic circuit board comprising an integrated computer chip, memory, and a power source all in electrical communication with each other;
a speaker arranged in the interior compartment and in electrical communication with the electronic circuit board and configured to play the pre-recorded sound when the activation button is activated.

4. The device of claim 3 further comprising a microphone arranged in the interior compartment and in electrical communication with the electronic circuit board and the electronic circuit board is further configured to record a new sound based on input from the activation button.

5. The device of claim 3 wherein the body is configured to resemble a fishing lure whereby the body comprises a silicon-based polymer skin painted to resemble fish scales.
